(19) United States
(12) Patent Application Publication
(10) Pub. No.: US 2002/0026389 A1
(43) Pub. Date: Feb. 28, 2002

(54) Shopping system based on information retrieval

(75) Inventor: Isamu Suzuki, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/932,894

(22) Filed: Aug. 21, 2001

(30) Foreign Application Priority Data
Aug. 25, 2000 (JP) 2000-256377

(51) Int. Cl. G06F 17/60

(52) U.S. Cl. 705/27

(57) ABSTRACT

An object of the present invention is to provide a shopping system which allows a user to designate a retrieval priority item and allows a retrieval information service terminal to narrow down information, thereby easily retrieving a target commodity at the time of providing the user a retrieval information list. The present invention is characterized in that latest commodity information is obtained through an information communication network, and a retrieval information list is constituted on a retrieval service terminal so that a user side terminal can acquire the retrieval information list; and based on an information retrieval request relating to a commodity selected from the retrieval information list by the user, the retrieval service terminal collates the commodity information provided by the dealer with the information retrieval request, and refers shopping information narrowed down and thereby specified to the user side terminal.

### BACKGROUND OF THE INVENTION

1. Field of the Invention

The present invention relates to a shopping system based on information retrieval or so-called electronic commerce system.

2. Description of the Prior Art

A shopping system (or online shopping service) of this type is normally effective in the avoidance of labor for visiting several shops and comparing the shops with respect to commodity stock and prices for respective dealers when a user does the shopping at shops.

However, the existing shopping system leaves it to a user side to select a commodity which the user wants to buy from enormous quantity of data. Due to this, even if a retrieval information list is presented hierarchically, the operation of the retrieval is laborious to the user since the user selects information on each hierarchy. As a result, the existing shopping system is disadvantageously incapable of promptly extracting the commodity under the conditions which satisfy the user.

Further, if a dealer dealing in a user's desired commodity is remote from the user, the user cannot visit the dealer's shop directly and buy the commodity. This, therefore, requires the user to laboriously access the dealer using communication means to request a purchase order.

Further, unlike a case where a user directly comes in touch with commodities and judges whether to buy one, such a shopping system cannot bring the user actual feeling. Due to this, there is no avoiding potential time loss and labor such as the return of the commodity after purchase.

However, even if the user visits a shopping district including many shops so as to purchase the commodity, there is no avoiding time loss such as the search of a shop selling the commodity at the lowest price.

Under the above-stated circumstance, the present invention has been made.

### SUMMARY OF THE INVENTION

It is the first object of the present invention to provide a shopping system which allows a user to designate a retrieval priority item or the like and allows a retrieval information service terminal to narrow down information, to thereby reduce a user-side selection range and to make it possible to easily retrieve a target commodity at the time of providing a retrieval information list to the user.

It is the second object of the present invention to provide a shopping system which can instantly realize an advance purchase order to a dealer in response to a retrieval result.

It is the third object of the present invention to provide a shopping system which, if a user side terminal is a portable terminal having a function of i-mode for browsing internet information, WAP (wireless application protocol), Bluetooth (short range wireless interface) or EZ-Web (character information service for mobile terminals), allows the retrieval information service terminal to automatically specify the transmission range of the portable terminal and to narrow down information on a relevant commodity to thereby reduce the selection range of the user side terminal and to facilitate retrieval.

Accordingly, the present invention is characterized in that latest commodity information is obtained from a dealer through an information communication network, and a retrieval information list constituted in a particular format is constituted on a retrieval service terminal so that a user side terminal can acquire the retrieval information list; and based on an information retrieval request relating to a commodity selected from the retrieval information list by the user, the retrieval service terminal collates the commodity information provided by the dealer with the information retrieval request, and refers shopping information narrowed down and thereby specified to the user side terminal.

In this case, it is effective as modes for carrying out the present invention that the dealer is referred to in response to a commodity purchase request of the user side based on the shopping information, and mediation of the commodity purchase is realized; the retrieval service terminal shows a menu for designating a priority retrieval item when offering the retrieval information list to the user, and specifies a content of the offered retrieval information list in accordance with the designated priority retrieval item; and when the user side terminal accesses the retrieval service terminal through the communication network, the retrieval service terminal specify a transmission range of the user side terminal, selects dealers selling a target commodity, makes a list for a required number of the dealers and provides the list to the user side terminal.

According to the present invention, the user transmits the shopping information retrieval request from the user side terminal to the information retrieval service terminal through the information network, and the information retrieval service terminal narrows down information based on the transmitted information, whereby the user can receive the necessary information or a business model from the information retrieval service terminal without giving a burden to the user.

Due to this, the user can acquire the name, address (including map information), specific commodity price, stock and the like of the shop which offers the lowest price of the commodity which the user wants to purchase. As a result, it is possible for an individual to save money and make effective use of time and for an organization to improve productivity. Further, since the user can also receive the retrieval result on the portable terminal, the use can use the system and receive a service without being restricted by place and time.

### BRIEF EXPLANATION OF THE DRAWINGS

FIG. 1 is a block diagram typically showing a mode for carrying out the present invention.

FIG. 2 is a flow chart of the first mode showing processing procedures for a shopping system of the present invention.

FIG. 3 is a flow chart of the second mode for carrying out the present invention.

FIG. 4 is a flow chart of the third mode for carrying out the present invention.

FIG. 5 is a view showing an example of retrieval screen display on a user side terminal.

### PREFERRED EMBODIMENT OF THE INVENTION

Modes for carrying out the present invention will be concretely described hereinafter with reference to the drawings.

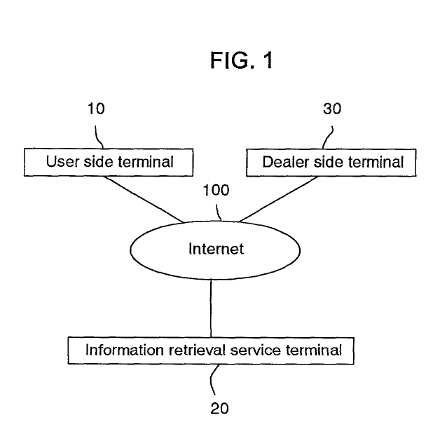

As shown in FIG. 1, in the first mode for carrying out the present invention, a shopping system consists of a user's terminal computer 10 (to be referred to as user side terminal hereinafter), an information retrieval service company (or center) side terminal computer 20 (to be referred to as information retrieval service terminal hereinafter), a dealer's (such as shops or sales company) terminal computer 30 (to be referred to as dealer side terminal hereinafter) and the Internet (or information communication network) 100 mutually connecting these constituent elements.

A user accesses the information retrieval service terminal 20 through the Internet 100 using user's user side terminal 10 and acquires a list of priority retrieval items (to be described later) with respect to information retrieval. Upon making menu selection, the user transmits a retrieval request with respect to information on commodity (such as a mini-disc (MD) player) which is desired to be retrieved by the user, to the information retrieval service terminal 20 (mainly consisting of an information processing apparatus including a workstation, a server and the like) through the Internet 100.

When receiving the information retrieval request, the information retrieval service terminal 20 narrows down information based on the content of the user's retrieval request and latest information (such as the names of shops, the names of commodities, the number of stocks, prices, addresses (including additional information such as a map)) in a database installed in the terminal 20, and transmits the retrieval result to the user side terminal 10 through the Internet 100.

On the other hand, the information retrieval service terminal 20 constantly receives latest information (such as the names of the shops, the names of the commodities, the number of stocks, prices and addresses) from the dealer side terminal 30 through the Internet 100 and updates the information in the database.

The user side terminal 10 selects a commodity from the narrowed-down retrieval information displayed on the screen of the display section of the terminal 10.

More specifically, the information retrieval service terminal 20 receives, for example, the retrieval request information transmitted from the user side terminal 10 by a user's operation, generates information on the name of a dealer, the name, address, price (lowest price) and stock of a dealer offering the lowest price of a product designated by the user based on latest dealer information stored in a workstation server, i.e., sales conditions and the like as well as the retrieval request information received from the user, and transmits the retrieval result to the user terminal 10.

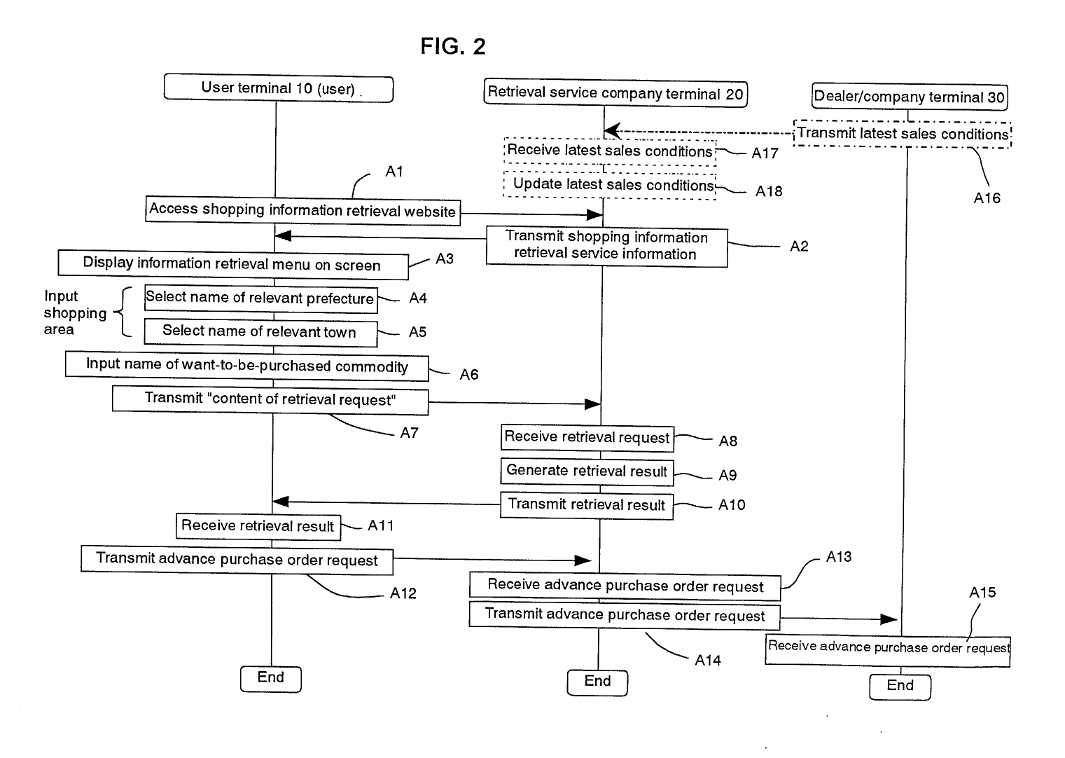

Next, the concrete processing steps of the system will be described with reference to FIG. 2. First, the user accesses a shopping information retrieval web-site opened by the information retrieval service terminal 20 on the Internet 100 through the user's user side terminal 10 (in a step Al). In response to the access, the information retrieval service terminal 20 transmits retrieval information for shopping information to the user terminal 10 (in a step A2).

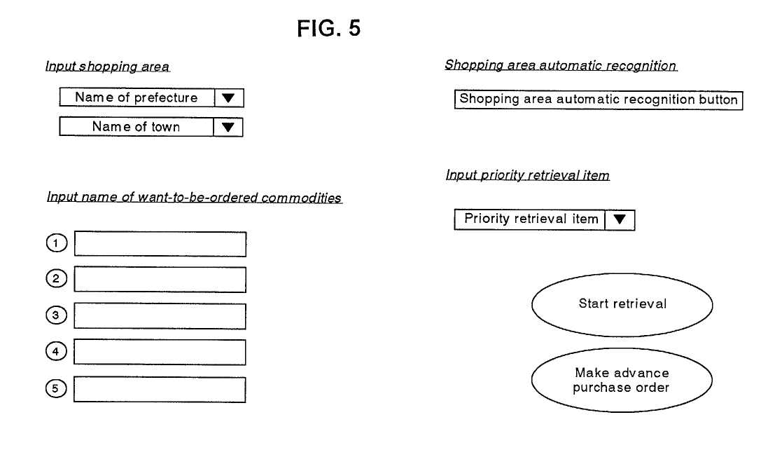

First, as shown in FIG. 5, an information retrieval menu is displayed on a screen on the user side terminal 10 (in a step A3). If a drop-down list of “names of prefectures” among shopping area input items is clicked on in the displayed “information retrieval menu” screen, the names of nationwide prefectures are displayed and the name of the prefecture necessary for retrieval is clicked on and selected (in a step A4).

Next, if a drop-down list of “names of towns” is clicked on, the names of towns in the relevant region are displayed and the name of the necessary town is clicked on and selected (in a step A5). The name of this town is recognized as a user's shopping area (i.e., retrieval target area=transmission area in this case).

Then, the name of a commodity which the user wants to purchase is inputted into a “want-to-be-purchased commodity” item in want-to-be-purchased commodity items (in a step A6). The user's retrieval request information thus registered is temporarily stored in the user side terminal 10. This retrieval request information stored in the user side terminal 10 is transmitted to the information retrieval service terminal 20 through the Internet 100 by a user's instruction (use's clicking on “retrieval” button shown in FIG. 5) (in a step A7).

If receiving the retrieval request information, the information retrieval service 20 narrows down information such as the name, address (including map information), price and stock of the shop/company which offers the lowest price based on the received information and the latest information (such as shop/company conditions) stored in the server and generates the narrowed-down information as a retrieval result (in a step A9).

Further, the information retrieval service terminal 20 transmits the retrieval result to the user side terminal 10 through the Internet 100 (in a step Al0). The user side terminal 10 receives this retrieval result (in a step A11). On the screen of the display section of the user side terminal 10, information including the name, address (including map information), price and stock of the shop/company which offers the lowest price is displayed.

In this mode for carrying out the invention, in particular, if an advance purchase order is necessary after looking at the received stock conditions, an “advance purchase order” button is clicked on and a request to make an advance purchase order of the commodity which the user wants to purchase is transmitted to the information retrieval service terminal 100 through the Internet (in a step A12). This information retrieval service terminal 20 receives the advance purchase order request from the user side terminal 10 (in a step A13). The information retrieval service terminal 20 transmits advance purchase order information on the commodity to a relevant dealer side terminal 30 based on the user's advance purchase order request (in a step A14). This dealer side terminal 30 receives the user's advance purchase order (in A15) and keeps the relevant commodity in custody until user's purchase payment (electronic remittance) arrives.

In this way, by adding the systems of stock check and advance purchase order to the shopping system of the present invention, it is possible to purchase a commodity which the user wants to purchase surely and easily.

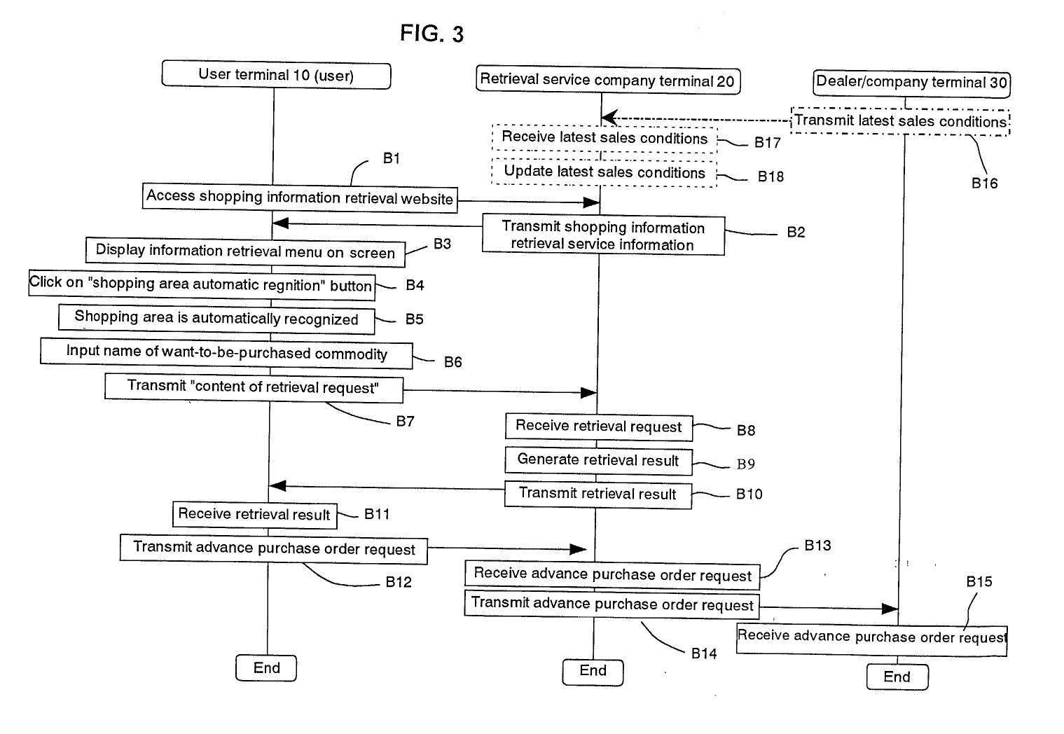

Next, the second mode according to the present invention will be described in detail with reference to FIG. 3. It is noted that a manner in which the system of the present invention is carried out is shown while assuming that if a user goes to, for example, a certain Electrical Shopping District and wants to purchase a mini-disc (MD) player, it is possible to instantly obtain information on a shop offering the lowest price in the Akihabara (or transmission region) area only by inputting the name of a commodity which the user wants to purchase, into a portable terminal.

That is, in this mode, a PHS (portable handyphone system in Japan) having a function of, for example, i-mode is employed as the user side terminal (note that normally, a portable terminal having i-mode, EZ-Web, WAP or Bluetooth function, the other mobile terminal or a personal computer is available).

In this mode for carrying out the invention, if the user uses the PHS as the user side terminal 10, the information retrieval service terminal can automatically recognize a user's shopping area and “shopping area input” operation (steps B4 and B5) are automated. In these respects, the second mode differs from the first mode.

Accordingly, when the user uses the user side terminal 10 (or PHS in this case) and clicks on the “shopping area automatic recognition” button, the present position of the user is automatically selected by the present position automatic recognition system of the PHS. Due to this, unless other designations are required, the “shopping area input operations” (steps A4 and A5) in the first mode can be skipped.

Next, the processing procedures of the system in this mode for carrying out the invention will be described. Namely, operations until the user carries out desired commodity arrival (steps B1 to B3) on the information retrieval menu of the user side terminal 10 are the same as the operations (steps A1 to A3) in the first mode for carrying out the invention.

First, the information retrieval menu as shown in FIG. 5 is displayed on the screen of the user side terminal 10 (in a step B3). Then, the “shopping area automatic recognition” button on the displayed “information retrieval menu” screen is clicked on. Next, the information retrieval service terminal automatically recognizes the user's present position, recognizes the user's present position as “shopping area” and automatically inputs the user's present position as shopping area information by the position recognition system of the PHS (in a step A5). The remaining steps (steps B6 to B15) are the same as the operations (steps A6 to A15) in the first mode for carrying out the present invention.

In this mode, if the above-stated portable terminal such as a PHS is used as the user side terminal 10, range designation is automatically made and several shops are listed (or referred) with respect to the lowest price of the commodity (or prices starting with the lowest price in order) by user's visiting a shopping district and transmitting information at the district. At this moment, if a map is displayed, the user can directly visit the listed shops. In this way, the user can hold down money paid to purchase the commodity and effectively utilize time.

The target commodity is not limited to the MD player stated above. For example, if a user purchase daily food at a supermarket or the like, the user can obtain information on cut-price commodities which prices are changed daily on the Internet and instantly know at which supermarket the user can purchase food to hold down total amount (since a calculation processing and the like are carried out by the information retrieval service terminal 20). As a result, the user can hold down payment and efficiently purchase commodities, while the dealer side can expect the assured attraction of customers through the advertisement of commodities sold at bargain.

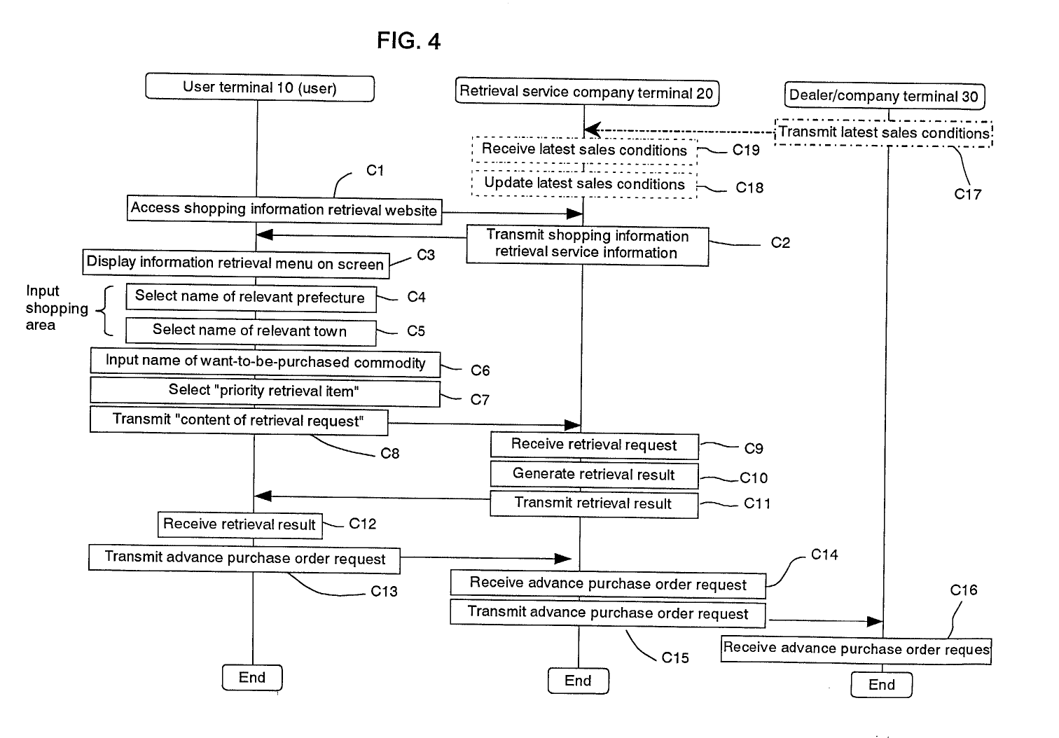

Next, the third mode for carrying out the present invention will be described in detail with reference to FIG. 4. This mode relates to a case where there are a plurality of commodities which a user wants to purchase. If the lowest prices for the individual commodities are offered by different shops, then the information retrieval service terminal 20 can calculates the total amount of a plurality of wanted commodities, select, for example, up to the fifth shops with respect to shops and companies (or dealers) which offer the lowest total amounts and obtain the retrieval result. This respect differs from the preceding first mode for carrying out the invention. The user inputs the names of a plurality of commodities which the user want to purchase (and the quantity thereof, if necessary) on the user side terminal 10 and then clicks on “retrieval” button to thereby complete retrieval request operation.

When receiving the retrieval request, the information retrieval service terminal 20 selects, for example, five high-ranking shops (or dealers) and transmits the result to the user side terminal 10 through the communication network 100.

Next, the processing operations of this mode for carrying out the invention will be described with reference to FIG. 4. Operations (steps C1 to C5) until the user inputs a shopping area on the information retrieval menu displayed on the screen of the user side terminal are the same as those in the first mode for carrying out the invention.

Next, the user inputs the names of a plurality of commodities which the user wants to purchase to want-to-be-purchased commodity items on the information retrieval menu (in a step C6). Then, the user clicks on a drop-down list of “priority retrieval items” on the information retrieval menu and clicks on and then selects either “area priority” or “price priority” (in a step C7). The user's retrieval request information thus registered is temporarily stored in the user side terminal 10.

The retrieval request information stored in the user side terminal 10 is transmitted to the information retrieval service terminal 20 through the information communication network 100 by a user's instruction (user's clicking on “retrieval” button shown in FIG. 3) (in a step C8).

When receiving the retrieval request information (in a step C9), the information retrieval service terminal 20 generates a retrieval result based on the received information and latest shops/company conditions stored in the server. If the user's priority retrieval item is “area priority”, the information retrieval service terminal 20 generates, as a retrieval result, information on, for example, the names, addresses (including map information), specific commodity prices, total amounts, stocks and the like of five high-ranking shops which offer the lowest total amounts in a designated shopping area with respect to total amounts of sales (in a step C10).

If the user's priority retrieval item is “price priority”, the information retrieval service terminal 20 generates, as a retrieval result, information on, for example, the names, addresses (including map information), specific commodity prices, total amounts, stocks and the like of five high-ranking shops which offer the lowest total amounts in a single prefecture with respect to total amounts of sales (in a step C10).

The information retrieval service terminal 20 transmits the retrieval result to the user side terminal 10 through the information communication network 100 (in a step C11) and the user side terminal 10 receives the retrieval result (in a step C12).

On the display of the user side terminal 10, the names, addresses (including map information), specific commodity prices, total amounts, stocks and the like of the five high-ranking shops which offer the lowest total amounts with respect to total amounts of sales are displayed.

The remaining operations (steps C13 to C16) are the same as the operations (steps A12 to A15) in the first mode for carrying out the invention.

What is claimed is:

1. A shopping system which comprises:
a plurality of dealer terminals for supplying commodity information through a network;
an information retrieval service terminal for gathering said commodity information through said network; and
a plurality of user terminals for asking for information retrieval of said commodity information through said network,
wherein a retrieval information list is constituted on said information retrieval service terminal so that said user terminal acquires said retrieval information list, and based on an information retrieval request by said user terminal relating to a commodity selected from said retrieval information list, said information retrieval service terminal collates said commodity information with said information retrieval request, and refers shopping information narrowed down and thereby specified to said user terminal.

2. The shopping system according to claim 1, wherein said information retrieval service terminal refers to said dealer terminal in response to said information retrieval request of said user terminal based on said shopping information, and mediates a purchase of commodity.

3. The shopping system according to claim 1, wherein said information retrieval service terminal shows a menu for designating a priority retrieval item when offering said retrieval information list to said user terminal, and specifies a content of said retrieval information list in accordance with said priority retrieval item designated by said user terminal.

4. The shopping system according to claim 1, wherein when said user terminal accesses said information retrieval service terminal through said network, said retrieval service terminal specifies a transmission range of said user terminal, selects dealers selling a target commodity, makes a list for a required number of the dealers and offers said list to said user terminal.
